(19) United States
(12) Patent Application Publication
(10) Pub. No.: US 2026/0110288 A1
(43) Pub. Date: Apr. 23, 2026

(54) METHOD FOR INSTALLING A WIND TURBINE TOWER

(71) Applicant: Siemens Gamesa Renewable Energy AS, Brande (DK)

(72) Inventors: Frederik Jul Bertelsen, Vejle (DK); Rene Kjeldbjerg, Toerring (DK); Jesper Panduro, Vandel (DK)

(21) Appl. No.: 19/166,738

(22) PCT Filed: Mar. 6, 2024
(86) PCT No.: PCT/EP2024/055856

§ 371 Date: Sep. 18, 2025

(30) Foreign Application Priority Data
Apr. 5, 2023 (EP) 23166681.9

(51) Int. Cl. F03D 13/20; F03D 13/40

(52) U.S. Cl. CPC F03D 13/206; F03D 13/402; F05B 2230/6102; F05B 2260/30

(57) ABSTRACT

A method for installing a wind turbine tower is provided, wherein the tower includes a tower fastening portion and a tower through hole in the tower fastening portion, including: providing a vessel with a vessel fastening portion and a vessel through hole in the vessel fastening portion, landing the tower onto the vessel with the tower through hole at the vessel through hole, positioning a stud in the tower through hole and the vessel through hole, wherein the stud includes an upper portion protruding from the tower through hole in an upward direction and a lower portion protruding from the vessel through hole in a downward direction, fastening the tower fastening portion to the vessel fastening portion by a lower fastening element attached to the lower portion and an upper fastening element attached to the upper portion, wherein the lower fastening element and the upper fastening element are both detachable from the stud in a non-destructive way.

### CROSS-REFERENCE TO RELATED APPLICATIONS

This application is a national stage of PCT Application No. PCT/EP2024/055856, having a filing date of Mar. 6, 2024, which claims priority to EP Application No. 23166681.9, having a filing date of Apr. 5, 2023, the entire contents both of which are hereby incorporated by reference.

### FIELD OF TECHNOLOGY

The following relates to a method for installing a wind turbine tower and in particular for seafastening the wind turbine tower for transporting the tower on a vessel to a foundation.

### BACKGROUND

In prior art, it is known to install the tower on a vessel for transporting it to a foundation with screws and nuts. When seafastening the tower on the vessel, there is limited space for handling the screws and bolts because of tower internals and other equipment inside the tower. Further, it is difficult to handle the screws manually because of the size and/or weight of the studs.

Until now, screws like cylinder head screws are used for fastening wind turbine towers via a tower fastening portion to a vessel fastening portion. When installing the tower at the vessel fastening portion, the screws are guided through vessel through holes in the vessel fastening portion with the screw heads on a lower portion of the screws. That is, the screws are pushed from bottom to top in an upward direction through the vessel through holes and the coaxially positioned tower through holes, until the upper part of the screws protrude from the tower through holes in an upward direction and the screw heads contact the outer surfaces of a lower part of the vessel fastening portions around the vessel through holes. Thereafter, a nut is screwed onto each upper portion of the screws protruding from the tower through holes. After the vessel with the tower on it has reached the foundation for the tower, the screws are replaced by new screws, which are inserted into the tower through holes in a downward direction, that is, from top to bottom, after the older screws have been removed.

Since the vessel is moving, for example on water, installation times on the vessel have to be as short as possible in order to prevent unintentional damages to the tower. This is challenging in particular when it comes to replacing the old screws by the new screws for lifting the tower from the vessel to the foundation.

### SUMMARY

An aspect relates to addressing the above mentioned issues. In embodiments, an aspect relates to an improved method for seafastening a wind turbine tower.

According to embodiments of the present invention, a method is provided for installing a wind turbine tower, wherein the tower comprises a tower fastening portion and a tower through hole in the tower fastening portion, comprising the steps of:
providing a vessel with a vessel fastening portion and a vessel through hole in the vessel fastening portion,
landing the tower onto the vessel with the tower through hole at the vessel through hole,
positioning a stud in the tower through hole and the vessel through hole, wherein the stud comprises an upper portion protruding from the tower through hole in an upward direction and a lower portion protruding from the vessel through hole in a downward direction,
fastening the tower fastening portion to the vessel fastening portion by a lower fastening element attached to the lower portion and an upper fastening element attached to the upper portion,
wherein the lower fastening element and the upper fastening element are both detachable from the stud in a non-destructive way.

Within the scope of embodiments of the present invention, it has been found that replacing the traditional screw by the stud without the screw head provides the possibility of an improved way of installing the tower onto the vessel. In embodiments, the tower can be installed in a way that provides an improved starting position for moving the tower from the vessel to the foundation later on.

Having the stud with the lower fastening element being detachable from the stud, that is, having no fixed screw head, it is possible to just remove and/or detach the lower fastening element from the stud for lifting the tower from the vessel. Further, the old and/or initial stud will then be reused for fastening the tower onto the foundation. Hence, the stud can be reused during the installation process of the tower. Even the lower fastening means may be reused, depending on the given circumstances and/or safety requirements. In addition, the inventive method not only simplifies embodiments of the method known in prior art but also provides the basis for a faster way of moving and installing the tower from the vessel onto the foundation.

The above described method is not restricted to the order of the above indents. That is, an alternative order of the described method steps is possible. For example, positioning the stud in the vessel through hole may be performed before and/or during landing the tower onto the vessel. Attaching the lower fastening element may be performed before or after positioning the stud in the vessel through hole and/or the tower through hole.

The tower through hole can be understood as at least one tower through hole. The vessel through hole can be understood as at least one vessel through hole. The stud can be understood as at least one stud. That is, it is possible that the tower is fastened to the vessel by a plurality of studs in a corresponding plurality of tower through holes and vessel through holes. The described steps may then be performed after one another or in a combined manner. For example, in one alternative, every stud may be inserted into the holes and when every stud is in position, the fastening elements are attached and fastened. According to another alternative, the tower may be fastened onto the vessel by one stud in the described manner and by at least one further stud in the same manner.

The upper portion may be understood as an upper end portion of the stud. The lower portion may be understood as a lower end portion of the stud. The stud may comprise an external thread in the lower portion, the upper portion and/or over the entire length of the stud. The stud may be provided as a rod—and/or pin-shaped stud.

The tower fastening portion may be understood as a fastening portion, for example a flange portion, in a lower and/or bottom part of the tower. Hence, the tower through hole may be located in a tower flange of the tower fastening portion. In this way, conflicts with tower internals can be prevented when handling the stud or studs. The vessel through hole may be located in a vessel flange of the vessel fastening portion.

The vessel can be understood as a floating and/or ship-like platform for transporting the tower to a foundation at sea. However, the vessel may also be understood as a land-based transportation platform. Landing the tower onto the vessel may be understood as moving and/or lifting the tower onto the vessel. Fastening the tower fastening portion to the vessel fastening portion may be understood as fixing and/or mounting the tower fastening portion to the vessel fastening portion. Fastening the tower fastening portion to the vessel fastening portion by the lower fastening element and the upper fastening element may be understood such that the lower fastening element and the upper fastening element may be used, in addition to further fastening tools like the stud and the fastening portions, for fastening the tower to the vessel.

According to an embodiment of the invention, the stud may be positioned in the vessel through hole such that the lower portion protrudes from the vessel through hole in the downward direction and the lower fastening element may be attached at the lower portion before the tower is landed onto the vessel. In this way, the stud with the attached lower fastening element may be pushed into the tower through hole as soon as the tower fastening portion is in a suitable position at the vessel fastening portion while having a mechanical stop by the lower fastening element.

In an embodiment of the invention it is possible that the stud is moved in the downward direction until the upper portion is located in the vessel through hole before and/or when landing the tower onto the vessel and the stud is moved in the upward direction until the upper portion is moved through the tower through hole and outside the tower through hole after the tower landed onto the vessel. In this way, the stud can be easily held in the desired position until the tower contacts the vessel and can then be quickly pushed into the tower through hole.

Moreover, the inventive method may be performed such that the lower fastening element is attached to the lower portion by screwing the lower fastening element onto the lower portion and the upper fastening element is attached to the upper portion by screwing the upper fastening element onto the upper portion. That is, the upper fastening element and the lower fastening element may each comprise an internal thread, by which they may be screwed onto the stud and the external thread, respectively. The lower fastening element and the upper fastening element may both be provided as nuts. In this way, the lower fastening element and the upper fastening element may be easily attached to the stud and detached from the stud. The lower fastening element and the upper fastening element being detachable from the stud in a non-destructive way may thus be understood such that they may be loosened and/or screwed off from the stud.

Furthermore, the stud may be rotated into the lower fastening element by using a mechanical rotation means. By automating the rotation of the stud into the lower fastening means, this process can be performed quicker, more consistent and with higher safety compared to conventional methods. Moreover, it is possible to use heavier studs like studs with a weight over 10 kg or over 15 kg. The mechanical rotation means may be provided as a robot for rotating and/or spinning the stud.

In addition, or alternatively, the lower fastening element may be attached at and/or to the lower portion by using a mounting shelf for holding the lower fastening element and/or for lifting the lower fastening element. In embodiments, the mounting shelf can be used for lifting the lower fastening element with the stud on the lower fastening element. For example, the lower fastening element may be supported at the mounting shelf, which might be part of a robot and/or machine. Then, the stud may be placed into the vessel through hole and onto the lower fastening element. That is, the stud is then supported by the lower fastening element and the mounting shelf. Thereafter, the stud may be attached to the lower mounting element, for example, may be manually screwed into the lower mounting element, which might be provided as a nut. Using the mounting shelf provides an improved way of attaching the lower fastening element to the stud. In embodiments, by supporting the stud on the lower fastening element and the mounting shelf, respectively, an easier handling of the stud can be achieved for the process of attaching the lower fastening element to the stud. The mounting shelf might comprise a mechanical, hydraulic and/or pneumatic lifting device for lifting and/or lowering the lower fastening element.

Embodiments of the inventive method may further comprise the following steps for installing the tower on a foundation, in particular on an offshore foundation:
detaching the lower fastening element from the stud,
lifting the tower from the vessel with the stud being at the tower fastening portion having the upper fastening element at the upper portion,
providing a foundation with a foundation fastening portion and a foundation through hole in the foundation fastening portion,
landing the tower onto the foundation with the tower through hole at the foundation through hole, while guiding the lower portion of the stud, still being at the tower fastening portion, through the foundation through hole,
attaching the lower fastening element at the lower portion,
fastening the tower fastening portion to the foundation fastening portion by the lower fastening element and the upper fastening element.

Having installed the lower fastening element instead of having a conventional screw head, the lower fastening element can be easily detached from the stud in order to lift the tower including the stud or studs and the upper fastening element or elements from the vessel. In this way, the critical time for fastening the tower onto the foundation can be held relatively short. The foundation through hole may be located in a foundation flange of the foundation fastening portion. The foundation may be understood as an offshore foundation but also as a platform, where the tower has to be installed eventually.

According to an embodiment of the present invention, the tower comprises a plurality of tower through holes, the vessel comprises a plurality of vessel through holes and/or the foundation comprises a plurality of foundation through holes, wherein a plurality of studs is positioned in the tower through holes and the vessel through holes, wherein each stud comprises an upper portion protruding from each tower through hole in an upward direction and a lower portion protruding from each vessel through hole in a downward direction. Further, each stud may be moved in the downward direction until each upper portion is located in each corresponding vessel through hole before and/or when landing the tower onto the vessel and each stud may be moved in the upward direction until each upper portion is moved through each corresponding tower through hole and outside each corresponding tower through hole after the tower landed onto the vessel. That is, no stud may protrude from the holes during landing of the tower. Moreover, the tower may be lifted from the vessel with each stud being at the tower fastening portion having attached the corresponding upper fastening element at each upper portion. In this way, the tower may be installed in an even more secure and still easy and space-saving manner.

### BRIEF DESCRIPTION

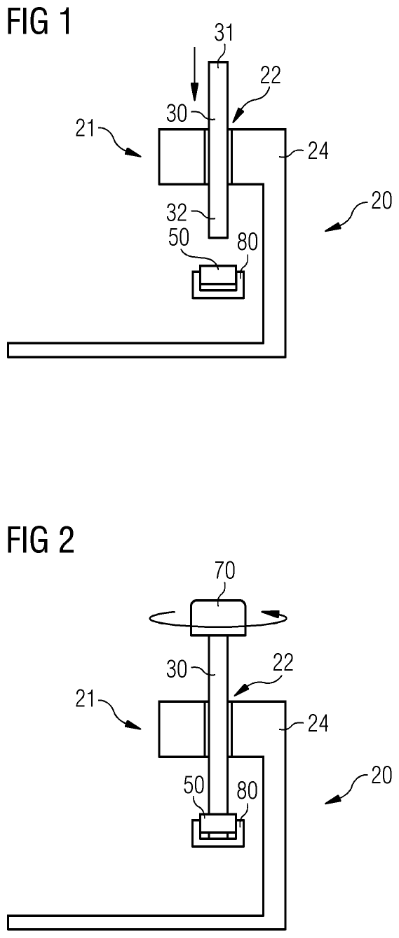

Some of the embodiments will be described in detail, with reference to the following figures, wherein like designations denote like members, wherein: FIG. 1 depicts a schematic view of a part of a vessel having a vessel fastening portion and a vessel through hole in the vessel fastening portion, in accordance with embodiments of the present invention;

FIG. 2 depicts a schematic view of a stud rotated into a lower fastening element by using a mechanical rotation means, in accordance with embodiments of the present invention;

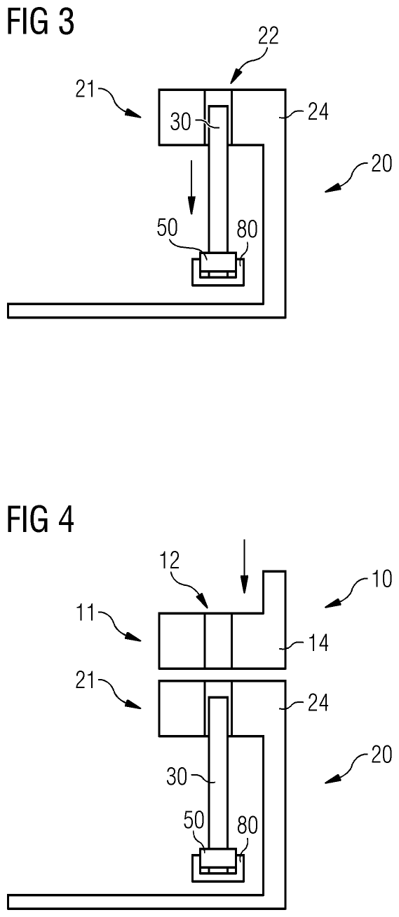

FIG. 3 depicts a schematic view of the stud being moved in a downward direction, in accordance with embodiments of the present invention;

FIG. 4 depicts a schematic view of a wind turbine tower landed onto the vessel, in accordance with embodiments of the present invention;

FIG. 5 depicts a schematic view of the stud being moved in the upward direction, in accordance with embodiments of the present invention;

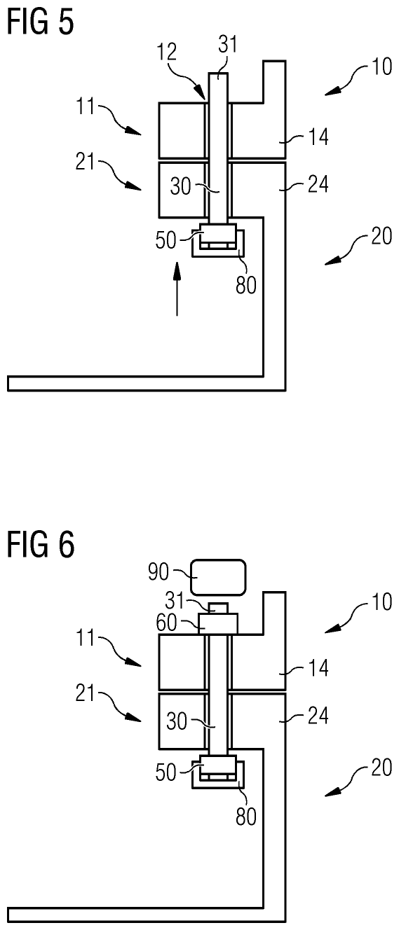

FIG. 6 depicts a schematic view of an upper fastening element attached to an upper portion of the stud, in accordance with embodiments of the present invention;

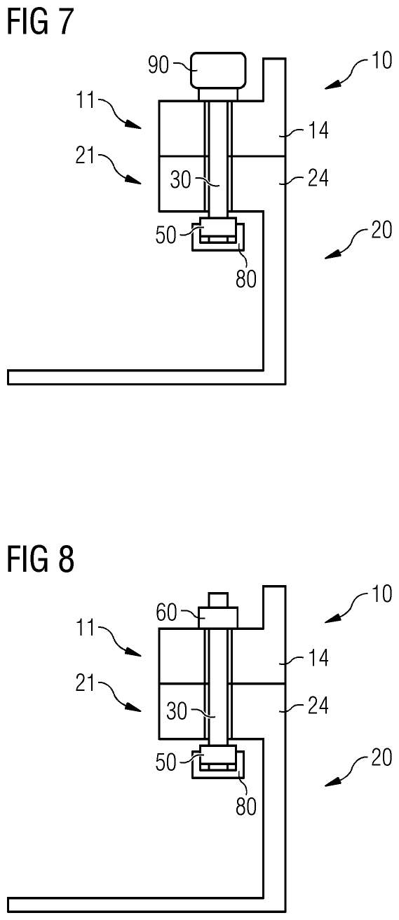

FIG. 7 depicts a schematic view of a fastening as a survival mode, in accordance with embodiments of the present invention;

FIG. 8 depicts a schematic view of a fastening in a transit mode, in accordance with embodiments of the present invention;

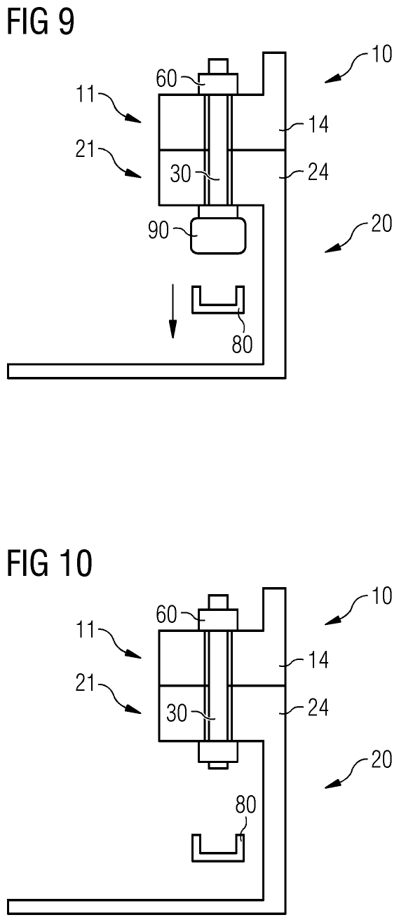

FIG. 9 depicts a further measure of safety, in accordance with embodiments of the present invention;

FIG. 10 depicts a schematic view of a sea transit of the tower on the vessel, during which the mounting shelf is moved and/or shifted into a lower position, in accordance with embodiments of the present invention;

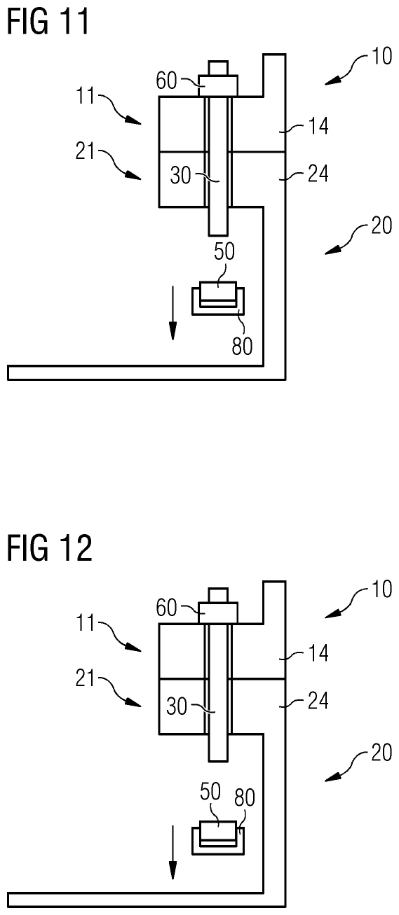

FIG. 11 depicts a schematic view of a state, in which the vessel arrived at a foundation and the lower fastening element is removed from the lower portion of a first stud by a mounting shelf in transit mode, in accordance with embodiments of the present invention;

FIG. 12 depicts a schematic view of a step of removing the further lower fastening element from a further stud in survival mode, in accordance with embodiments of the present invention;

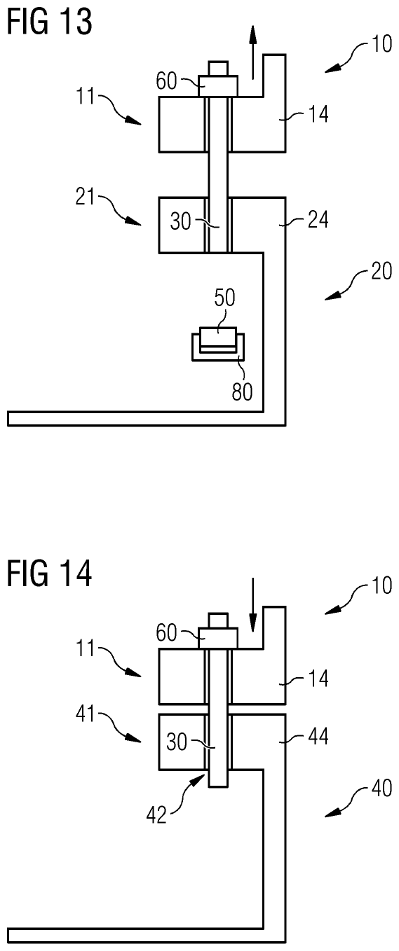

FIG. 13 depicts a schematic view of the tower being lifted from the vessel, in accordance with embodiments of the present invention;

FIG. 14 depicts a schematic view of the tower landed onto the foundation, in accordance with embodiments of the present invention;

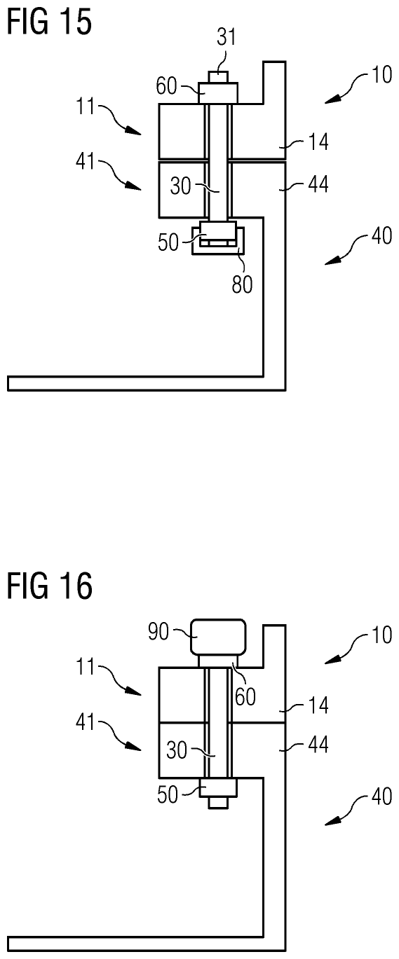

FIG. 15 depicts a schematic view of the lower fastening element attached at the lower portion, after the tower landed onto the foundation, in accordance with embodiments of the present invention;

FIG. 16 depicts a schematic view of the tower secured to the tower onto the foundation, in accordance with embodiments of the present invention;

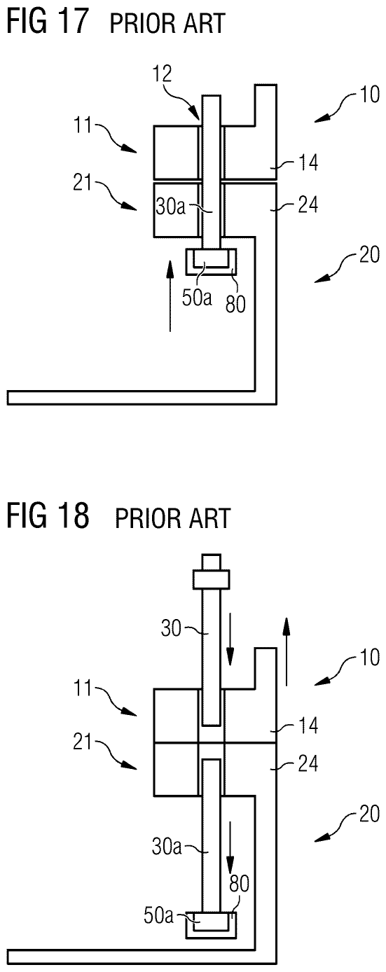

FIG. 17 depicts parts of a tower and a vessel according to prior art; and

FIG. 18 depicts parts of a tower and a vessel according to prior art.

Elements and features having the same function and operating principle are labeled with the same reference signs in the drawings.

### DETAILED DESCRIPTION

In FIG. 1, part of a vessel 20 is shown having a vessel fastening portion 21 and a vessel through hole 22 in the vessel fastening portion 21. The vessel fastening portion 21 comprises a vessel flange 24. FIG. 1 further shows a stud 30 in the vessel through hole 22, wherein the stud 30 comprises an upper portion 31 protruding from the tower through hole 12 in an upward direction and a lower portion 32 protruding from the vessel through hole 22 in a downward direction. Moreover, a lower fastening element 50 and a mounting shelf 80 are shown. In a first step of the installation, the stud 30 is moved downward through the vessel through hole 22 into the lower fastening element 50, which is supported at the mounting shelf 80. The stud 30 is provided as a threaded rod and the lower fastening element 50 is provided as a nut.

As shown in FIG. 2 the stud 30 is rotated into the lower fastening element 50 by using a mechanical rotation means 70. Depending on the weight of the stud 30, it could alternatively be screwed into the nut manually or the lower fastening element 50 could be screwed onto the stud 30 by holding the stud 30 still and rotating the lower fastening element 50, either manually or by the mounting shelf 80.

FIG. 3 shows the stud 30 being moved in a downward direction and in FIG. 4, a wind turbine tower 10 is landed onto the vessel 20. In embodiments, the tower fastening portion 11 is landed onto the vessel fastening portion 21. The tower fastening portion 11 comprises a tower through hole 12 and a tower flange 14, in which the tower through hole 12 is located. In the shown example, the stud 30 is positioned in the vessel through hole 22 such that the lower portion 32 protrudes from the vessel through hole 22 in the downward direction and the lower fastening element 50 is attached at the lower portion 32 before the tower 10 is landed onto the vessel 20. As can be seen in FIG. 3 and FIG. 4, the stud 30 is moved in the downward direction until the upper portion 31 is located in the vessel through hole 22 before landing the tower 10 onto the vessel 20.

As shown in FIG. 5, the stud 30 is moved in the upward direction until the upper portion 31 is moved through the tower through hole 12 and outside the tower through hole 12 after the tower 10 is landed in the desired position onto the vessel 20. That is, after the stud 30 is located in the tower through hole 12 and the vessel through hole 22, the upper portion 31 protrudes from the tower through hole 12 in the upward direction and the lower portion 32 protrudes from the vessel through hole 22 in the downward direction.

Thereafter, as shown in FIG. 6, an upper fastening element 60 is attached to the upper portion 31 of the stud 30. The upper fastening 60 is provided as a nut, which is screwed onto the stud 30.

Afterwards, a tensioning tool 90 is used to fasten the tower fastening portion 11 to the vessel fastening portion 21 by screwing the upper fastening element 60 further onto the stud 30. FIG. 8 shows a further stud 30 being located in a further tower through hole 12 and a further vessel through hole 22 for fastening the tower 10 in a more secure way to the vessel 20 by further fastening elements 50, 60. The fastening in FIG. 7 can be considered as a so called survival mode and the additional fastening shown in FIG. 8 can be considered as a so called transit mode. As a further measure of safety, as shown in FIG. 9, the tensioning tool 90 is used to further fasten the lower fastening element 50 as well. FIG. 10 shows a sea transit of the tower 10 on the vessel 20, during which the mounting shelf is moved and/or shifted into a lower position.

FIG. 11 shows the state, in which the vessel 20 arrived at a foundation 40 (shown in FIG. 14) and the lower fastening element 50 is removed from the lower portion 32 of the first stud 30 by the mounting shelf in transit mode. FIG. 12 shows the step of removing the further lower fastening element 50 from the further stud 30 in survival mode.

As can be seen in FIG. 13, the tower 10 will be lifted as soon as every lower fastening element 50 has been removed from every stud 30, wherein the tower 10 is lifted from the vessel 20 with the studs 30 being at the tower fastening portion 11. As shown in FIG. 13, the upper fastening elements 60 will remain at the studs 30 and the upper portions 31, respectively, when lifting the tower 10 from the vessel 20.

After the tower 10 was lifted from the vessel 20, it will be landed onto the foundation 40. The foundation 40 of the described example comprises a foundation fastening portion 41 and a foundation through hole 42 in the foundation fastening portion 41. In embodiments, the foundation through hole 42 is located in a foundation flange 44 of the foundation fastening portion 41. As shown in FIG. 14, the tower 10 is landed onto the foundation 40 with the tower through hole 12 at the foundation through hole 42, while guiding the lower portion 32 of the stud 30, still being at the tower fastening portion 11, through the foundation through hole 42.

After the tower 10 landed onto the foundation 40, as shown in FIG. 15, the lower fastening element 50 is attached at the lower portion 32. In embodiments, the nut shaped lower fastening element 50 is screwed onto the lower portion 32 of the stud 30 by the mounting shelf 80. Finally, the tower fastening portion 11 is fastened to the foundation fastening portion 41 by the lower fastening element 50 and the upper fastening element 60. As shown in FIG. 16, in order to secure the tower 10 onto the foundation 40, the upper fastening element 60 is tensioned by the tensioning tool 90.

The aforesaid description of the accompanying drawings is only by the way of detail and example. Specific features of each aspect of embodiments of the present invention and the figures can be combined which each other if of technical sense.

FIG. 17 and FIG. 18 show parts of a tower 10 and a vessel 20 according to prior art, in order to describe major differences between the conventional and the inventive way of installing the tower 10 on the vessel 20. As can be seen in FIG. 17, the screw 30a used for fastening the tower 10 onto the vessel 20 has a firm screw head 50a. When moving the tower 10 from the vessel 20 onto the foundation 40 afterwards, as shown in FIG. 18, the screw 30a has to be replaced by a further screw 30a. This way of processing is described in more detail in the introductory part of the description above.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for installing a wind turbine tower, wherein the tower comprises a tower fastening portion and a tower through hole in the tower fastening portion, the method comprising:
providing a vessel with a vessel fastening portion and a vessel through hole in the vessel fastening portion;
landing the wind turbine tower onto the vessel with the tower through hole at the vessel through hole;
positioning a stud in the tower through hole and the vessel through hole, wherein the stud comprises an upper portion protruding from the tower through hole in an upward direction and a lower portion protruding from the vessel through hole in a downward direction; and
fastening the tower fastening portion to the vessel fastening portion by a lower fastening element attached to the lower portion and an upper fastening element attached to the upper portion, wherein the lower fastening element and the upper fastening element are both detachable from the stud in a non-destructive way.

2. The method according to claim 1, wherein the stud is positioned in the vessel through hole such that the lower portion protrudes from the vessel through hole in the downward direction and the lower fastening element is attached at the lower portion before the tower is landed onto the vessel.

3. The method according to claim 2, wherein the stud is moved in the downward direction until the upper portion is located in the vessel through hole before and/or when landing the wind turbine tower onto the vessel and the stud is moved in the upward direction until the upper portion is moved through the tower through hole and outside the tower through hole after the wind turbine tower landed onto the vessel.

4. The method according to claim 1, wherein the lower fastening element is attached to the lower portion by screwing the lower fastening element onto the lower portion and the upper fastening element is attached to the upper portion by screwing the upper fastening element onto the upper portion.

5. The method according to claim 1, wherein the stud is rotated into the lower fastening element by using a mechanical rotation means.

6. The method according to claim 1, wherein the lower fastening element is attached at the lower portion by using a mounting shelf for holding the lower fastening element and/or for lifting the lower fastening element.

7. The method according to claim 1, further comprising:
detaching the lower fastening element from the stud;
lifting the wind turbine tower from the vessel with the stud being at the tower fastening portion having the upper fastening element at the upper portion;
providing a foundation with a foundation fastening portion and a foundation through hole in the foundation fastening portion;
landing the wind turbine tower onto the foundation with the tower through hole at the foundation through hole, while guiding the lower portion of the stud, still being at the tower fastening portion, through the foundation through hole;
attaching the lower fastening element at the lower portion; and
fastening the tower fastening portion to the foundation fastening portion by the lower fastening element and the upper fastening element.

8. The method according to claim 1, wherein the wind turbine tower comprises a plurality of tower through holes and/or the vessel comprises a plurality of vessel through holes, wherein a plurality of studs is positioned in the tower through holes and the vessel through holes, wherein each stud comprises an upper portion protruding from each tower through hole in an upward direction and a lower portion protruding from each vessel through hole in a downward direction.

9. The method according to claim 1, wherein the wind turbine tower comprises a plurality of tower through holes and/or the vessel comprises a plurality of vessel through holes, wherein a plurality of studs is positioned in the tower through holes and the vessel through holes, wherein each stud is moved in the downward direction until each upper portion is located in each corresponding vessel through hole before and/or when landing the tower onto the vessel and each stud is moved in the upward direction until each upper portion is moved through each corresponding tower through hole and outside each corresponding tower through hole after the tower landed onto the vessel.

10. The method according to claim 1, wherein the wind turbine tower comprises a plurality of tower through holes and/or the vessel comprises a plurality of vessel through holes, wherein a plurality of studs is positioned in the tower through holes and the vessel through holes, wherein the wind turbine tower is lifted from the vessel with each stud being at the tower fastening portion having attached the corresponding upper fastening element at each upper portion.
